(19) United States
(12) Patent Application Publication
(10) Pub. No.: US 2006/0141960 A1
(43) Pub. Date: Jun. 29, 2006

(54) Triggering an emergency mode in a radio communication system and methods thereof

(75) Inventors: Juan C. Fernandez, Boca Raton, FL (US); Scott M. Garrett, Weston, FL (US); Stuart S. Kreitzer, Coral Springs, FL (US); Joseph Patino, Pembroke Pines, FL (US); Jorge L. Perdomo, Boca Raton, FL (US); Camilo E. Villamil, Pembroke Pines, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 11/025,189

(22) Filed: Dec. 29, 2004

(51) Int. Cl. H04B 1/16; H04B 1/04

(52) U.S. Cl. 455/127.1; 455/343.1

(57) ABSTRACT

A mobile communication device (106) comprising a transceiver (202), and a processor (203) coupled to the transceiver. The processor is programmed to enter (304) an emergency mode corresponding to an alteration type of an element of the mobile communication device, and process (306) messages according to the emergency mode.

### FIELD OF THE INVENTION

This invention relates generally to emergency systems, and more particularly to triggering an emergency mode in a radio communication system and methods thereof.

### BACKGROUND OF THE INVENTION

In this day and age it has become routine for individuals to request emergency assistance by dialing emergency codes such as 911 on a cell phone. Situations arise, however, where it is not always possible for emergency personnel to readily ascertain the severity or the type of emergency when a caller has been injured and cannot speak clearly. There are also extremely dangerous situations like a kidnapping or an armed robbery where it may not be desirable for a caller to verbalize the emergency condition.

The embodiments of the invention presented below overcome the foregoing limitations in the art.

### SUMMARY OF THE INVENTION

Embodiments in accordance with the invention provide an apparatus and method for triggering an emergency mode in a radio communication system.

In a first embodiment of the present invention, a mobile communication device (MCD) coupled to a radio communication system (RCS) has a method comprising the steps of altering an element coupled to the MCD, entering at the MCD an emergency mode corresponding to an alteration type of the element, and processing messages at the MCD according to the emergency mode.

In a second embodiment of the present invention, a MCD comprising a transceiver, and a processor coupled to the transceiver. The processor is programmed to enter an emergency mode corresponding to an alteration type of an element coupled to the MCD, and process messages at the MCD according to the emergency mode.

In a third embodiment of the present invention, a method of operating a mobile communication device (MCD) comprises the steps of initiating an emergency operating mode of the MCD for providing an emergency functionality, and in response to initiating the emergency operating mode, inhibiting a normal operating functionality of the MCD.

### BRIEF DESCRIPTION OF THE DRAWINGS

FIG. 1 is an illustration of a radio communication system (RCS) for communicating with a number of MCDs in accordance with an embodiment of the present invention.

FIG. 2 is a block diagram of the MCD in accordance with an embodiment of the present invention.

FIG. 3 is a flow chart depicting a method for triggering an emergency mode in the RCS in accordance with an embodiment of the present invention.

### DETAILED DESCRIPTION

While the specification concludes with claims defining the features of embodiments of the invention that are regarded as novel, it is believed that the embodiments of the invention will be better understood from a consideration of the following description in conjunction with the figures, in which like reference numerals are carried forward.

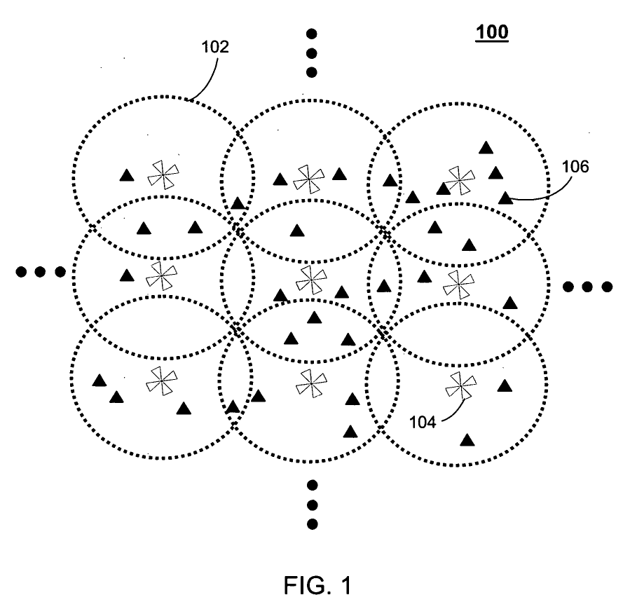

Referring to FIG. 1, an illustration of a radio communication system (RCS) 100 for communicating with a number of MCDs 106 is shown. The RCS 100 is a conventional wireless network comprising a plurality of radio base stations 104, each providing a communication range within a geographic cell site 102, which in the aggregate cover, for example, a metropolitan area. Each radio base station 104 is capable of transmitting and receiving conventional radio messages with the MCDs 106.

The RCS 100 and its elements are capable of long-range, mid-range or short-range communications. For example, in a first embodiment, the RCS 100 represents a cellular network for long-range communications with MCDs 106 employing conventional communication protocols such as CDMA (Code Division Multiple Access), TDMA (Time Division Multiple Access), or GSM (Global System for Mobile communications). Alternatively, the RCS 100 represents a WLAN (Wireless Local Area Network) for short to mid-range communications employing a conventional protocol such as IEEE 802.11.

In yet another embodiment, the RCS 100 and its elements combine the foregoing communication network embodiments. In this way the MCD 106 can switch between communication networks on the basis of proximity, availability of service and economic factors managed by a user of the MCD 106. For example, when an MCD 106 roams into an office space or a home, the MCD 106 can switch to a land line or VoIP (Voice Over Internet Protocol) service via the WLAN network. When the MCD 106, on the other hand, roams outside the reach of the WLAN, it communicates with a conventional long-range cellular network.

For illustration purposes only, the description below will focus on an embodiment of the RCS 100 as a cellular network. It will be appreciated by one of ordinary skill in the art that the embodiments of the invention are applicable to any radio communication system that is capable of relaying voice and/or data messages between the MCD 106 and any other communication device.

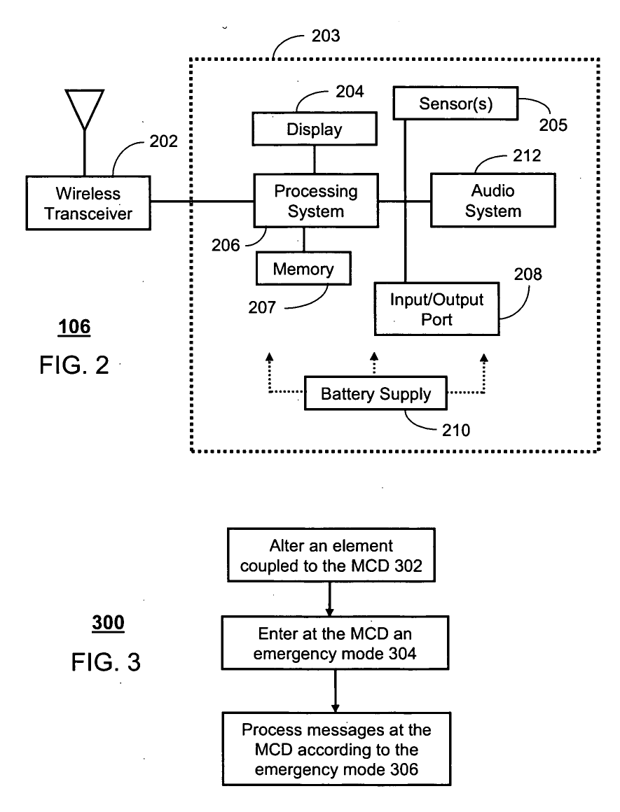

FIG. 2 is a block diagram of the MCD 106 in accordance with an embodiment of the present invention. The MCD 106 comprises conventional components such as a wireless transceiver 202 and a processor 203 carried in a conventional casing (not shown) of plastic and/or metallic subassemblies. The wireless transceiver 202 employs conventional transceiver technology for transmitting and receiving radio messages to and from one or more radio base stations 104 of the RCS 100.

The processor 203 includes a display 204, one or more sensors 205, a processing system 206, a memory 207, an input/output port 208, a battery supply 210 that supplies power to all elements 202-212 of the MCD 106, and an audio system 212.

The processing system 206 includes a microprocessor (or like processing device), and software applications stored in the memory 207 for controlling operations of the foregoing components 202-212 according to the invention described herein. The processing system 206 is capable of processing voice and data messages as well as providing a user interface (UI) for selecting applications such as multi-media applications (e.g., video MPEG 4 player, video games, etc.), which can be presented by way of the display 204, and when appropriate, can be presented audibly through the audio system 212.

The input/output port 208 can provide connectivity with devices by physical and/or wireless coupling. Where physical connectivity is employed, devices or accessories can be coupled to the MCD 106 utilizing any number of conventional connectivity techniques integrated in the input/output port 208: wired tethering, direct attachment to the MCD 106 by way of a connector, optical-mechanical coupling, or other forms of physical coupling. Where wireless connectivity is employed, wireless devices or wireless accessories can be coupled to the MCD 106 utilizing any number of conventional wireless connectivity techniques integrated in the input/output port 208: radio communications like Bluetooth or IEEE 802.11, electromagnetic signals, optical signals, or other forms of conventional wireless coupling.

The input/output port 208 can also be coupled to other components of the processor 203 such as, for example, the battery supply 210. In this embodiment, the input/output port 210 can detect the presence, insertion, removal, or alteration of the battery supply 210 utilizing conventional sensing techniques integrated in the sensors 205.

The sensors 205 can also provide other conventional sensing attributes measurable by the processing system 206 such as: 1) temperature; 2) longitudinal and latitudinal location; 3) altitudinal location relative to a reference (e.g., sea level); 4) audible signals recorded from the vicinity of the MCD 106; 5) damage to an element of the MCD 106; 6) toxin detection (e.g., smoke or other poisonous gases); 7) voice or fingerprint biometrics; and 8) extraction, insertion, modification, or other form of alteration of an element of the MCD 106.

Considering the innumerable options for physical and wireless coupling of elements to the MCD 106, it would be obvious to one of ordinary skill in the art that it would be impractical to outline all possible functions of the input/output port 208.

In one embodiment contemplated by the invention, portions or components of the MCD 106 may be considered as being coupled to the MCD 106. For example, one popular form of MCD 106 is a folding, or “clam shell” form. In a folding style MCD 106, each half of the MCD 106 is coupled to the other half. Likewise, smaller portions or components may be thought of as being coupled to the MCD 106, such as, for example, an adhesive label, a battery cover, an antenna, a keypad bezel, and so on. It is likewise contemplated that the altering may be initiated by a user of the MCD 106 by, for example, entering an emergency code on a keypad of the MCD 106, or upon selecting an emergency mode from a menu or submenu of options presented to the user by a user interface of the MCD 106.

Similarly, there are countless sensing techniques that can be incorporated into the sensors 205. It would therefore be obvious to said artisan that any connectivity and/or sensing embodiments not mentioned herein, or modifications or additions made to the embodiments described herein that are applicable to the present invention are intended to be within the scope and spirit of the claims below.

FIG. 3 is a flow chart depicting a method 300 for triggering or initiating an emergency mode in the RCS 100 in accordance with an embodiment of the present invention. By emergency mode it is meant that the MCD 106 provides an enhanced functionality not provided during normal operation. The method 300 begins with step 302, where an element coupled to the MCD 106 is altered. The element can be any portion or component 202-212 of the MCD 106, including its casing. Furthermore, the alteration as will be described below can be caused by a user of the MCD 106 or the RCS 100. In step 304, the processor 203 enters an emergency mode corresponding to an alteration type of the element. The alteration type comprises at least one among a group of alterations including extracting in whole or in part the element from the MCD 106, inserting in whole or in part the element into the MCD 106, and modifying in whole or in part the element of the MCD 106.

The following list are brief examples of altered elements:
Insert a tab or a pin in whole or in part into the casing of the MCD 106
Remove a tab or a pin in whole or in part from the casing of the MCD 106
Remove in whole or in part a portion of the casing of the MCD 106
Remove a medicinal component carried in the casing of the MCD 106
Remove in whole or in part a label attached to an element of the MCD 106 (e.g., the battery supply 210)
Modify in whole or in part an element of the MCD 106. Examples of this include updating a portion of the memory 207 with an emergency code or sequence transmitted by the RCS 100, updating the same by way of biometric data provided by a user of the MCD 106, destroying a portion of the casing, and/or tearing a label from the casing of the MCD 106.

Each of the foregoing alterations are associated with an emergency mode and corresponding severity level. The associations can be established confidentially between a user of the MCD 106 and administrators of the RCS 100. Alternatively, the administrator of the RCS 100 can provide the user of the MCD 106 options for associating alterations with emergency modes, whereby the formation of such associates would be known only to the user. The emergency modes and corresponding association with alterations are stored in the MCD 106 in, for example, the memory 207 of the processor 203.

The severity level, can be divided into three categories: extreme emergency requiring a rapid response (e.g., a kidnapping, life-threatening bodily injury, lost skier in an avalanche, terrorist attack, etc.); mid-level emergency requiring a timely response e.g., car accident with no life-threatening injuries); and nominal emergency requiring a reasonably timed response (e.g., automobile running out fuel). More elaborate severity resolutions can be used if needed.

A user of the MCD 106 may thus choose to associate removal of a pin from the MCD 106 with an emergency mode corresponding to an extreme emergency such as a kidnapping. This alteration would be detected by the sensors 205 coupled to the input/output port 208, which in turn informs the processor 203 that an emergency has occurred with a corresponding alteration type. The processor 203 compares the alteration type to the emergency modes stored in the memory 207 and enters in step 304 an emergency mode corresponding to the alteration type. The association between the emergency mode and the alteration type can be distinct according to the emergency event (e.g., kidnapping, terrorist attack, or other) or can be generic (extreme emergency) independent of the event that triggered the emergency notice.

After the emergency is triggered, in step 306, the processor 203 is programmed to provide an emergency functionality which is a functionality not provided during normal operation, such as, for example, to process messages at the MCD 106 according to the emergency mode. Such messages are then transmitted to the RCS 100 according to the severity level. One or more of these messages includes information concerning a state of the MCD 100. The state includes at least one among a group of states such as a location state, an environment state, a confidential information state, and/or the emergency mode state. Another example of an emergency functionality is increasing the transmit power of the MCD 106 beyond a maximum level allowed during normal operation. Another example is providing access to medicine disposed in a container coupled to the MCD 106. Numerous other examples of emergency functionality may be provided by the MCD 106.

The location state can provide a three dimensional fix of the MCD 106 as determined by the sensors 205 using conventional sensing techniques such as an altimeter and/or a GPS (Global Positioning Satellite) sensor. If the sensors 205 are detected by the processor 203 to have malfunctioned, then the processor 203 can be programmed to submit the last known location of the MCD 106. The environment state, on the other hand, can include audio signals within the vicinity of the MCD 106, temperature and/or toxic readings (e.g., smoke, chemical attack).

The confidential information state includes personal information such as medical history, existing medical condition and medication, last will and testament, personal identification, next of kin, spouse's name and contact information in the event of an emergency, and so on. The emergency mode state provides the RCS 100 valuable information to assess an appropriate response for assisting a user of the MCD 106. For instance, the severity level of the emergency mode can trigger an immediate communication link to the appropriate emergency personnel (police department, fire department, homeland security department, FBI, CIA, and/or NSA) without requiring the user of the MCD 106 to dial a particular number.

Depending on the severity level, the processor 203 can also be programmed to transmit stealth messages (anecdotally similar to silent alarms). When the severity level corresponds to an extreme emergency like an armed robbery this embodiment can be very useful. Stealth messages can include transmission of any one of the above states without providing any sensory indications in the MCD 106 that such transmissions are taking place.

In this mode, the processor 203 operates the MCD 106 as if to appear to an observer that the unit is in idle mode. Moreover, if the person performing the criminal act attempts to turn off the MCD 106 after the emergency mode has been entered, the processor 203 can be programmed to turn off the display 204, but continue to process and transmit the state of the MCD 106 to authorities. Additionally, where the sensors 205 detect an attempt to remove the battery, the MCD 106 can send the last known location state to the RCS 100, and/or with a backup battery incorporated in the processor 203, send periodic messages under a low power setting.

In yet another embodiment of the present invention, the processor 203 can be programmed to direct the wireless transceiver 202 to transmit messages at an amplified signal power to the RCS 100. This is especially useful in terrain where it is known that there is spotty or poor coverage between the MCD 106 and the RCS 100. In severe emergencies, the RCS 100 can similarly transmit messages to the MCD 106 at an amplified signal power.

As mentioned earlier, an alteration to an element of the MCD 106 can be triggered by the RCS 100. The alteration type can be, for instance, a code or sequence that is transmitted to the MCD 106 thereby altering a portion of the memory 207. This in turn causes the processor 203 to enter the MCD 106 in an emergency mode commensurate with the alteration type, and begin to process messages accordingly. This embodiment can be useful in situations where a terrorist attack has taken place in a particular location, and emergency personnel want to gather as much information as possible from MCDs 106 in this location. Emergency personnel can accomplish this by instructing the RCS 100 to transmit an alteration message to all MCDs 106 within one or more cell sites 102 in the vicinity of the emergency, thereby placing the MCDs 106 in an emergency mode that prompts transmission of relevant state information.

A similar application could be used in a skiing accident where a skier has been buried in an avalanche and emergency personnel have requested the RCS 100 to find the skier via the skier's MCD 106 that presumably is still with the skier or near by. Emergency personnel can instruct the RCS 100 to transmit messages at amplified signal power from one or more of the base stations 104 in the vicinity of the accident. Upon receiving these messages, the processor 203 can be instructed to alter the memory 207 (or other alterable element) entering the MCD 106 in an emergency mode for transmitting the environment state such as temperature, location, altitude (which can be used to assess depth of skier below the snow), or other data helpful to the rescuers.

Similarly, a user may be lost, having wandered outside the normal range of any of the serving areas of RCS 100. In one embodiment of the invention, alteration of the MCD 106 causes the MCD 106 to transmit at an amplified power level that is higher than is allowed under normal operating conditions. That is, the amplified power is higher than a maximum power level used under normal operating conditions. Furthermore, it is contemplated that when operating in such an emergency high power mode, the MCD 106 may indicate in transmissions that it outside the normal range of the RCS 100. The indicating may be performed, for example, by setting emergency bits in a bit field in the overhead portion of data frames transmitted to the RCS 100. In response to receiving such a transmission from the MCD 106 operating in an emergency high power mode, the RCS 100 may boost transmission power from the base station that receives the emergency high power transmission above a maximum normal power level used during normal, non-emergency operation to ensure reception by the MCD 106 while outside the normal range of the RCS 100. Operating in the emergency high power mode may allow transmission of location information to assist in finding the user of the MCD 106, or allow medical personnel to instruct the user in first aid procedures if necessary, or both, for example.

In yet another embodiment, the processor 203 is programmed to modify memory usage according to the severity level. This embodiment helps to avoid obstructions in processing of messages during an emergency due to a low capacity in the memory 207. In a low capacity situation, the processor 203 can be programmed to purge portions of the memory 207 having low information priority.

In response to initiating the emergency mode, the MCD 106 may inhibit one or more normal functions of the MCD 106. By inhibiting one or more normal functions of the MCD 106, a user is discouraged from initiating the emergency mode in the absence of exigent circumstances. For example, upon initiating the emergency mode, certain portions of the user interface may be disabled. The user may not be allowed to access records or other data the user has stored on the MCD 106, for example. The inhibiting of normal functionality may occur immediately upon entering the emergency mode, or at some preselected time period thereafter to allow temporary access to all function and the emergency functions for a period of time.

The inhibition of normal functionality may occur as a result of physically altering an element of the MCD 106, such as by breaking off a portion of the MCD 106, where the broken off portion normally provides a function. For example, in a folding style MCD 106 that provides telephony and dispatch calling modes, the earpiece portion of the MCD 106 may be broken off to initiate a high power dispatch functionality. By breaking off the earpiece portion, however, telephony functionality is inhibited. For each of the embodiments described above, the emergency mode can be removed upon restoration of the element to its original form. This can be accomplished by the user of the MCD 106 and/or administrators of the RCS 100. The restoration may include replacement of an element (e.g., a torn label), reinsertion or removal of an element, resetting of an element (e.g., clear memory of the emergency code sent by the RCS 100), or other pertinent form of restoration.

In light of the foregoing description, it should be evident that embodiments in the present invention could be realized in hardware, software, or a combination of hardware and software. These embodiments could also be realized in numerous configurations contemplated to be within the scope and spirit of the claims below.

It should also be understood that the claims are intended to cover the structures described herein as performing the recited function and not only structural equivalents. The claims below are sufficiently general to include equivalent structures. For example, a software implementation of method 300 described above and a hardware implementation of the same may not be structural equivalents in that the software implementation is dependent on the processing system 206 for execution, while the hardware implementation may have self-contained processing means to execute the same operation. It is well known in the art, however, that software and hardware implementations may be designed so as to operate as equivalent structures generating the same results. Accordingly, all equivalent modifications and/or additions to the invention as described above are intended to be within the scope and spirit of the claims recited herein.

What is claimed is:

1. In a mobile communication device (MCD) coupled to a radio communication system (RCS), a method comprising the steps of:
altering an element coupled to the MCD;
entering at the MCD an emergency mode corresponding to an alteration type of the element; and
processing messages at the MCD according to the emergency mode.

2. The method of claim 1, wherein the step of entering further comprises the step of entering the emergency mode corresponding to alteration types associated with extracting in whole or in part the element from the MCD, inserting in whole or in part the element into the MCD, and modifying in whole or in part the element of the MCD.

3. The method of claim 1, further comprising the step of removing the emergency mode upon restoring the element to its original form.

4. The method of claim 1, wherein the processing step comprises the step of transmitting a state of the MCD to the RCS.

5. The method of claim 4, wherein the state comprises at least one among a group of states comprising a location state, an environment state, a confidential information state, and the emergency mode state.

6. The method of claim 1, further comprising the step of transmitting from the RCS an alteration message to the MCD, and wherein the altering step alters the element according to the alteration message.

7. The method of claim 1, wherein the emergency mode has a severity level corresponding to the alteration type.

8. The method of claim 7, further comprising the step of transmitting at least one among messages to the RCS according to the severity level, stealth messages to the RCS according to the severity level, and messages with amplified power to the RCS according to the severity level.

9. The method of claim 8, further comprising, in response to receiving messages transmitted with amplified power from the MCD at the RCS, increasing the power of signals transmitted to the MCD by the RCS above a maximum normal operating power.

10. The method of claim 7, further comprising the step of modifying memory usage in the MCD according to the severity level.

11. A mobile communication device (MCD) in a radio communication system (RCS), comprising:
a transceiver; and
a processor coupled to the transceiver, wherein the processor is programmed to:
enter an emergency mode corresponding to an alteration type of an element coupled to the MCD; and
process messages according to the emergency mode.

12. The MCD of claim 11, wherein the alteration type comprises at least one among a group of alterations comprising extraction in whole or in part of the element from the MCD, insertion in whole or in part of the element into the SCR, and modification in whole or in part of the element of the MCD.

13. The MCD of claim 11, wherein the processor is further programmed to transmit a state of the MCD to the RCS and the state comprises at least one among a group of states comprising a location state, an environment state, a confidential information state, and the emergency mode state.

14. The MCD of claim 11, wherein the emergency mode has a severity level corresponding to the alteration type, and wherein the processor is further programmed to transmit said messages to the RCS according to the severity level.

15. The MCD of claim 11, wherein the processor is further programmed to:
receive an alteration message from the RCS; and
alter the element according to the alteration message.

16. A method of operating a mobile communication device (MCD), comprising:
initiating an emergency operating mode of the MCD for providing an emergency functionality; and
in response to initiating the emergency operating mode, inhibiting a normal operating functionality of the MCD.

17. A method of operating a MCD, as defined in claim 22, wherein initiating the emergency operating mode comprises at least one among physically altering an element of the MCD, altering a software component of the MCD, increasing the power transmissions from the MCD beyond a maximum normal level, and dispensing medicine stored in the MCD.

18. A method of operating a MCD, as defined in claim 16, wherein inhibiting the normal operating functionality of the MCD results from physically altering the element of the MCD.

19. A method of operating a MCD, as defined in claim 16, wherein inhibiting the normal operating functionality of the MCD occurs either concurrently with initiating the emergency operating mode or within a preselected period of time of initiating the emergency operating mode.

20. A method of operating a MCD, as defined in claim 16, wherein inhibiting the normal operating functionality of the MCD comprises inhibiting a normal function of a user interface of the MCD.
